(19) United States
(12) Patent Application Publication
(10) Pub. No.: US 2026/0275090 A1
(43) Pub. Date: Sep. 17, 2026

(54) RUBBER COMPOSITION COMPRISING A SPECIFIC PLASTICIZING SYSTEM

(71) Applicant: COMPAGNIE GENERALE DES ETABLISSEMENTS MICHELIN, Clermont-Ferrand (FR)

(72) Inventors: MARINE BONNEVIDE, Clermont-Ferrand (FR); FABIEN BONNETTE, Clermont-Ferrand (FR)

(21) Appl. No.: 19/168,656

(22) PCT Filed: Mar. 26, 2024
(86) PCT No.: PCT/EP2024/058132

§ 371 Date: Sep. 24, 2025

(30) Foreign Application Priority Data
Mar. 28, 2023 (FR) FR2302965

(51) Int. Cl. C08L 15/00; B60C 1/00; C08K 3/04; C08K 3/06; C08K 3/22; C08K 3/36; C08K 5/09; C08K 5/18; C08K 5/31; C08K 5/47; C08K 5/58

(52) U.S. Cl. CPC C08L 15/00; B60C 1/00; C08K 3/04; C08K 3/06; C08K 3/36; C08K 5/09; C08K 5/18; C08K 5/31; C08K 5/47; C08K 5/58; C08K 2003/2296

(57) ABSTRACT

A rubber composition is based on at least: an elastomer matrix consisting of an SBR or of a mixture of one SBR and at least one other SBR, a reinforcing filler comprising silica, a plasticizing system comprising 2 to 50 phr of a liquid plasticizer, and 10 phr to 80 phr of a terpene resin selected from alpha-pinene homopolymers, beta-pinene homopolymers, copolymers of alpha-pinene and beta-pinene, and mixtures thereof, the weight ratio of the resin to the liquid plasticizer being greater than or equal to 2/1, and a crosslinking system. The use of the rubber composition for the manufacture of tires not only affords an excellent compromise between rolling resistance and wet grip while providing a good level of tread block tear strength, it also makes it possible to respond to a desire to increase the content of sustainable materials in tires.

### TECHNICAL FIELD

The present invention relates to rubber compositions intended in particular for the manufacture of rubber articles such as tyres or semi-finished products for tyres. In particular, the invention is concerned with such rubber compositions, comprising a specific plasticizing system, which may be entirely or partially biobased.

In the current context of saving energy and preserving the environment, manufacturers are constantly looking for new renewable sources that can be used as raw materials for the manufacture of products.

For this purpose, tyre manufacturers are seeking to reduce the environmental impact of the manufacture of tyres and their use.

The reduction in the hysteresis of the rubber compositions used for the manufacture of tyres has long been a constant objective of designers in order to obtain tyres having a reduced rolling resistance in order to limit fuel consumption. However, those skilled in the art know that improving this performance is often to the detriment of the grip of the tyre, in particular on wet ground, which is promoted by increasing hysteresis.

Among the levers also available to tyre designers is the gradual replacement of fossil resource-derived materials with sustainable materials. Materials of biobased origin constitute some of these sustainable materials.

There is abundant literature available regarding the replacement of products of fossil origin, in rubber compositions intended for the manufacture of tyres, with products of biobased origin, in particular regarding plasticizers.

However, the use of sustainable materials must not be to the detriment of the safety and expected performance of the tyre, and these are difficult to all reconcile at the same time. In particular, endurance and grip must be high and rolling resistance must be low in order to minimize fuel consumption. Thus, the products of biobased origin used in the tyre must perform technically as well as the products prepared from raw materials of fossil origin.

Thus, the technical problem to be addressed is that of providing a rubber composition for tyres which has good hysteresis and tear strength properties while also contributing to a reduction in its environmental impact, in order to ensure good performance of the tyre in terms of endurance and wet grip, and also rolling resistance.

### DISCLOSURE OF THE INVENTION

The applicant has discovered, surprisingly, that the use of a plasticizing system based on a liquid plasticizer and on a specific terpene resin makes it possible not only to achieve an excellent compromise between hysteresis losses and tan delta at 0° C. (which describes the compromise between rolling resistance and wet grip of a tyre) while ensuring a good level of tear strength (which describes the tread block tear strength, i.e. the endurance of a tyre), but also to use an at least partially biobased plasticizing system which makes it possible to respond to a desire to increase the content of sustainable materials in tyres.

### SUMMARY OF THE INVENTION

The invention therefore relates to a rubber composition based on at least an elastomer matrix consisting of an SBR or of a plurality of SBRs, a reinforcing filler comprising silica, a crosslinking system and a plasticizing system, which plasticizing system comprises a liquid plasticizer and a terpene resin selected from alpha-pinene homopolymers, beta-pinene homopolymers, copolymers of alpha-pinene and beta-pinene, and mixtures thereof.

The invention particularly relates to a rubber composition according to any one of the following embodiments:
1. Rubber composition based on at least:
   an elastomer matrix consisting of an SBR or of a mixture of one SBR and at least one other SBR,
   a reinforcing filler comprising silica,
   a plasticizing system comprising
      2 to 50 phr of a liquid plasticizer, and
      10 phr to 80 phr of a terpene resin selected from alpha-pinene homopolymers, beta-pinene homopolymers, copolymers of alpha-pinene and beta-pinene, and mixtures thereof, the weight ratio of the resin to the liquid plasticizer being greater than or equal to 2/1,
   a crosslinking system.
2. Composition according to embodiment 1, in which at least one SBR has a Tg of greater than −70° C., the Tg being determined using a differential calorimeter according to standard ASTM D3418 (1999).
3. Composition according to either one of the preceding embodiments, in which the elastomer matrix consists of one SBR.
4. Composition according to any one of the preceding embodiments, in which at least one SBR is an SBR modified with a group capable of interacting with silica.
5. Composition according to any one of the preceding embodiments, in which at least one SBR is an SBR modified with a group comprising an SiOR or SiOH function, R being a C₁-C₄ alkyl.
6. Composition according to any one of the preceding embodiments, in which at least one SBR is an SBR modified with a group comprising an SiOH function located at the chain end.
7. Composition according to any one of the preceding embodiments, in which at least one SBR is an SBR modified with a group of formula —SiMe₂SiOH located at the chain end.
8. Composition according to any one of the preceding embodiments, in which at least one SBR is an SBR modified with an amine function.
9. Composition according to any one of the preceding embodiments, in which at least one SBR is an SBR modified with an amine function and a group comprising an SiOR or SiOH function, R being a C₁-C₄ alkyl.
10. Composition according to any one of the preceding embodiments, in which the content of reinforcing filler is within a range extending from 40 phr to 200 phr.
11. Composition according to any one of the preceding embodiments, in which the reinforcing filler comprises silica, carbon black or a mixture of silica and carbon black.
12. Composition according to any one of the preceding embodiments, in which the reinforcing filler predominantly comprises silica.
13. Composition according to any one of the preceding embodiments, in which the reinforcing filler comprises silica in a content within a range extending from 40 phr to 160 phr, preferably extending from 60 to 120 phr.
14. Composition according to any one of the preceding embodiments, in which the content of liquid plasticizer is within a range extending from 5 to 30 phr, preferably from 5 to 10 phr.
15. Composition according to any one of the preceding embodiments, in which the liquid plasticizer is a vegetable oil or a glycerol triester of plant origin.
16. Composition according to any one of the preceding embodiments, in which the content of terpene resin is within a range extending from 15 to 60 phr, preferably extending from 30 to 60 phr.
17. Composition according to any one of the preceding embodiments, in which the weight ratio of terpene resin to liquid plasticizer is within a range extending from 2/1 to 10/1, and is preferably within a range extending from 2/1 to 8/1.
18. Composition according to any one of the preceding embodiments, in which the terpene resin is selected from alpha-pinene homopolymers and beta-pinene homopolymers.
19. Composition according to any one of the preceding embodiments, in which the terpene resin has the following characteristics:
   (i) a softening point within a range extending from 80° C. to 140° C., preferentially from 110° C. to 135° C.
   (ii) a Tg within a range extending from 35° C. to 90° C., preferentially from 60° C. to 85° C.
   (iii) a number-average molecular weight within a range extending from 500 g/mol to 1300 g/mol and preferentially from 500 to 1000 g/mol.
20. Finished or semi-finished product comprising a rubber composition as defined in any one of the preceding embodiments.
21. Tyre comprising a rubber composition as defined in any one of the preceding embodiments.
22. Tyre, the tread of which comprises a rubber composition as defined in any one of the preceding embodiments.

### Definitions

The expression “parts by weight per hundred parts by weight of elastomer” (or phr) should be understood as meaning, within the meaning of the present invention, the parts by weight per hundred parts by weight of elastomer or rubber.

In the present document, unless expressly indicated otherwise, all the percentages (%) indicated are percentages (%) by weight.

Furthermore, any interval of values denoted by the expression “between a and b” represents the range of values extending from more than a to less than b (i.e. limits a and b excluded), whereas any interval of values denoted by the expression “from a to b” means the range of values extending from a up to b (i.e. including the strict limits a and b). In the present text, when an interval of values is denoted by the expression “from a to b”, this also preferentially denotes the interval represented by the expression “between a and b”.

In the present document, the expression composition “based on” means a composition comprising the mixture or the reaction product of the various constituents used, some of these base constituents being capable of reacting or intended to react with one another, at least in part, during the various phases of manufacture of the composition, in particular during the crosslinking or vulcanization thereof. By way of example, a composition based on an elastomer matrix and on sulfur comprises the elastomer matrix and the sulfur before curing, whereas, after curing, the sulfur has reacted with the elastomer matrix, forming sulfur (polysulfide, disulfide, monosulfide) bridges.

When reference is made to a “predominant” compound, this means, for the purposes of the present invention, that this compound is predominant among the compounds of the same type in the composition, that is to say that it is the one which represents the greatest amount by weight among the compounds of the same type. Preferentially, this is the compound which represents, for example, more than 50%, 60%, 70%, 80%, 90%, or even 100% by weight relative to the total weight of the type of compound. Thus, for example, a predominant reinforcing filler is the reinforcing filler representing the greatest weight relative to the total weight of the reinforcing fillers in the composition. In contrast, a “minor” compound is a compound which does not represent the greatest fraction by weight among the compounds of the same type.

The compounds mentioned in the description may be of fossil origin or may be biobased. In the latter case, they may be partially or totally derived from biomass or obtained from renewable raw materials derived from biomass. Similarly, the compounds mentioned may also originate from the recycling of already-used materials, i.e. they may partially or totally result from a recycling process, or else be obtained from raw materials which themselves result from a recycling process. Polymers, plasticizers, fillers, and the like, are concerned in particular.

### DETAILED DESCRIPTION OF THE INVENTION

### 1.1. Elastomer Matrix

The rubber composition according to the invention comprises an elastomer matrix, said matrix consisting of an SBR or of a mixture of one SBR and at least one other SBR. In other words, the elastomer matrix of the composition comprises 100 phr of SBR in the form of a single SBR or of a mixture of two or more SBRs.

While this definition has been given, it does not exclude the possibility of traces of other elastomers being present without them having an impact on the properties of the rubber composition.

According to one embodiment of the invention, the elastomer matrix consists of a single SBR.

SBR means a styrene-butadiene copolymer. “The SBR” will be used to denote the single elastomeric SBR in the matrix or, in the case of a mixture of SBRs, one of the SBRs in the mixture. “At least one SBR” will be used to denote the single elastomeric SBR in the matrix or, in the case of a mixture of SBRs, at least one of the SBRs in the mixture.

The SBR that is useful for the purposes of the invention may contain between 99% and 20% by weight of diene units and between 1% and 80% by weight of vinylaromatic units. It may have any microstructure, which depends on the polymerization conditions used, in particular on the presence or absence of a modifying and/or randomizing agent and on the amounts of modifying and/or randomizing agent employed. The SBR may be, for example, a block, random, sequential or microsequential elastomer and may be prepared in dispersion or in solution.

According to one embodiment of the invention, at least one SBR has a Tg of greater than −70° C. In other words, according to this embodiment, the matrix consists of an SBR having a Tg of greater than −70° C. or of a mixture of an SBR having a Tg of greater than −70° C. and of at least one other SBR. In the case of a mixture of SBRs, the matrix preferably comprises the SBR having a Tg of greater than −70° C. as the predominant elastomer. More preferentially, such a mixture consists of more than 50% of SBR having a Tg of greater than −70° C., more preferably still of at least 70% of such an SBR.

The SBR that is useful for the invention may be modified. It may be coupled and/or star-branched, or else functionalized with a coupling and/or star-branching or functionalizing agent. Thus, the SBR that is useful for the invention may comprise at least one functional group. The term “functional group” means a group comprising at least one heteroatom selected from Si, N, S, O or P. Particularly suitable as functional groups are those comprising at least one function, such as: silanol, an alkoxysilane, a primary, secondary or tertiary amine which is cyclic or non-cyclic, a thiol or an epoxide.

According to one embodiment of the invention, at least one SBR is modified with a group capable of interacting with silica.

According to one embodiment of the invention, at least one SBR is modified with a group bearing an SiOH (silanol) function or an SiOR function, R being a C₁-C₁₀ alkyl radical, preferably a C₁-C₄ alkyl radical, more preferably still methyl or ethyl.

Generally, a function borne by an elastomer may be located on the elastomer chain in one of three possible configurations: along the elastomer chain as a pendent group, at one end of the elastomer chain or else within the actual elastomer chain (i.e. not at the ends). The latter case occurs in particular when the elastomer is functionalized using a coupling or star-branching agent which provides the function in question.

According to a particular embodiment, at least one SBR is modified with a functional group comprising a silanol SiOH function. The functional group is then preferentially located at the chain end in the form of a silanol function or a polysiloxane block having a silanol end, in particular in the form of a dimethylsilanol —SiMe₂SiOH group. SBRs modified with a functional group comprising a silanol SiOH are well known and have been described, for example, in documents EP0778311 A1, WO2008/141702 A1, WO2015/018600 A1 or WO2011/042507 A1.

According to another particular embodiment, at least one SBR is modified with a functional group comprising a function of formula SiOR, in which R is a C₁-C₁₀ alkyl radical, preferably a C₁-C₄ alkyl radical, more preferably still methyl or ethyl.

According to another preferential embodiment, at least one SBR modified with a group bearing an SiOH (silanol) function or an SiOR function also bears at least one other function different from the SiOR or SiOH function. This other function is preferentially selected from the group consisting of epoxy, thiol or amine functions, it being possible for the amine to be a primary, secondary or tertiary amine. This other function is very preferentially an amine function, more preferentially still a tertiary amine. SBRs modified with a group bearing an SiOH function or an SiOR function and bearing at least one other function are also well known and have for example been described in documents US20050203251 A1, WO2015/018743A1, WO2009/133068A1, WO 2017/001683A1, WO2007/047943 A1, EP1457501 A1

In the embodiment of the invention according to which the elastomer matrix consists of a mixture of one SBR and at least one other SBR, this other SBR differs from the first in its microstructure and/or macrostructure. It may also be coupled and/or star-branched, or else functionalized with a coupling and/or star-branching or functionalizing agent.

### 1.2. Reinforcing Filler

According to the invention, the rubber composition comprises a reinforcing filler comprising silica. The rubber composition of the invention may comprise a reinforcing filler apart from silica.

Use may be made of any type of “reinforcing” filler known for its abilities to reinforce a rubber composition which can be used in particular for the manufacture of tyres, for example an organic filler such as carbon black, an inorganic filler other than silica, or else a mixture of these fillers.

Suitable carbon blacks are all carbon blacks, in particular the blacks conventionally used in tyres or their treads. Among the latter, mention will be made more particularly of the reinforcing carbon blacks of the 100, 200 and 300 series, or the blacks of the 500, 600 or 700 series (ASTM D-1765-2017 grades), for instance the N115, N134, N234, N326, N330, N339, N347, N375, N550, N683 and N772 blacks. These carbon blacks may be used in isolated form, as commercially available, or in any other form, for example as support for some of the rubber engineering additives used. The carbon blacks might, for example, be already incorporated in the elastomer matrix in the form of a masterbatch (see, for example, applications WO 97/36724-A2 or WO 99/16600-A1).

Suitable reinforcing inorganic fillers other than silica are in particular mineral fillers of the aluminous type, in particular alumina (Al₂O₃).

The silica used may be any reinforcing silica known to those skilled in the art, in particular any precipitated or fumed silica having a BET specific surface area and also a CTAB specific surface area both of less than 450 m²/g, preferably in a range extending from 30 to 400 m²/g, in particular from 60 to 300 m²/g.

Use may be made of any type of precipitated silica, in particular highly dispersible precipitated silicas (HDS). These precipitated silicas, whether highly dispersible or not, are well known to those skilled in the art and are commercially available. Mention may be made, for example, of the silicas described in applications WO03/016215-A1 and WO03/016387-A1. Among the commercial HDS silicas, use may in particular be made of the Ultrasil® 5000GR and Ultrasil® 7000GR silicas from Evonik or the Zeosil® 1085GR, Zeosil® 1115 MP, Zeosil® 1165MP, Zeosil® Premium 200MP and Zeosil® HRS 1200 MP silicas from Solvay. Use may be made, as non-HDS silica, of the following commercial silicas: the Ultrasil® VN2GR and Ultrasil® VN3GR silicas from Evonik, or the Hi-Sil EZ120G(-D), Hi-Sil EZ160G(-D), Hi-Sil EZ200G(-D), Hi-Sil 243LD, Hi-Sil 210 and Hi-Sil HDP 320G silicas from PPG.

The physical state in which the silica is provided is not important, regardless of whether it is in the form of a powder, of microbeads, of granules, or else of beads or any other appropriate densified form. Of course, “silica” also means mixtures of different silicas as described above.

Those skilled in the art will understand that, as a replacement for the the silica described above, use might be made of a reinforcing filler of another nature, provided that this reinforcing filler of another nature is covered with a layer of silica. By way of example, mention may be made of carbon blacks partially or totally covered with silica, or carbon blacks modified with silica, such as, but not limited to, fillers of the Ecoblack® type of the CRX2000 series or of the CRX4000 series from Cabot Corporation.

Those skilled in the art will know how to adjust the total content of reinforcing filler and its nature according to the use in question, in particular according to the type of tyre in question or the type of composition of the tyre. The total content of reinforcing filler is within a range extending from 40 to 200 phr, more preferentially from 45 to 180 phr and even more preferentially from 50 to 160 phr, the optimum being, in a known way, different according to the specific applications targeted.

According to a particular embodiment of the invention, the reinforcing filler comprises predominantly silica; preferably, it comprises more than 50% by weight of silica relative to the total weight of the reinforcing filler. According to this embodiment, the silica is preferably used in a content within a range extending from 40 to 160 phr, preferably from 40 to 140 phr, more preferably still from 60 to 120 phr. Optionally according to this embodiment, the reinforcing filler also comprises carbon black. According to this option, the carbon black is used in a content of less than or equal to 20 phr, more preferentially less than or equal to 10 phr (for example, the carbon black content may be within a range extending from 0.5 to 20 phr, in particular extending from 1 to 10 phr). Within the ranges indicated, the colouring (black pigmentation agent) and anti-UV properties of carbon blacks are exploited, without otherwise penalizing the typical performance provided by the reinforcing inorganic filler.

In the present disclosure, the BET specific surface area is determined by gas adsorption using the Brunauer-Emmett-Teller method described in “The Journal of the American Chemical Society”, (vol. 60, page 309, February 1938), and more specifically according to a method derived from the standard NF ISO 5794-1, Annex E, of June 2010 [multipoint (5 point) volumetric method—gas: nitrogen—degassing under vacuum: one hour at 160° C.—relative pressure p/p₀ range: 0.05 to 0.17].

For inorganic fillers such as silica, for example, the CTAB specific surface area values were determined according to the standard NF ISO 5794-1, Annex G of June 2010. The process is based on the adsorption of CTAB (N-hexadecyl-N,N,N-trimethylammonium bromide) on the “outer” surface of the reinforcing filler.

In order to couple the silica to the SBR(s) of the elastomer matrix, use may be made, in a well-known manner, of an at least difunctional coupling agent (or bonding agent) intended to provide a satisfactory interaction, of chemical and/or physical nature, between the silica (surface of its particles) and an SBR. Use is made in particular of organosilanes or polyorganosiloxanes which are at least difunctional. The term “difunctional” means a compound having a first functional group capable of interacting with the silica and a second functional group capable of interacting with an SBR. For example, such a difunctional compound may comprise a first functional group comprising a silicon atom, said first functional group being capable of interacting with the hydroxyl groups of the silica, and a second functional group comprising a sulfur atom, said second functional group being capable of interacting with an SBR.

Preferentially, the organosilanes are selected from the group consisting of (symmetrical or asymmetrical) organosilane polysulfides such as bis(3-triethoxysilylpropyl) tetrasulfide, abbreviated to TESPT, sold under the name Si69 by Evonik, or bis(triethoxysilylpropyl) disulfide, abbreviated to TESPD, sold under the name Si75 by Evonik, polyorganosiloxanes, mercaptosilanes, blocked mercaptosilanes, such as S-(3-(triethoxysilyl)propyl) octanethioate sold by Momentive under the name NXT Silane. More preferentially, the organosilane is an organosilane polysulfide.

Of course, use might also be made of mixtures of the coupling agents described above.

The content of coupling agent in the composition of the invention is advantageously less than or equal to 30 phr, it being understood that it is generally desirable to use as little as possible thereof. Typically, the content of coupling agent represents from 0.5% to 15% by weight relative to the amount of silica. This content is readily adjusted by those skilled in the art according to the content of silica used in the composition of the invention.

### I-3 Plasticizing System

The rubber composition according to the invention is based on a plasticizing system comprising at least one liquid plasticizer and a specific plasticizing terpene resin.

For the purposes of the invention, the content of liquid plasticizer is within a range extending from 2 phr to 50 phr. According to one embodiment, the content of liquid plasticizer is within a range extending from 5 to 30 phr, or else from 5 to 10 phr.

The liquid plasticizer is a liquid (at 23° C.) plasticizing agent, the function of which is to soften the matrix by diluting the elastomer and the reinforcing filler; its Tg is preferentially less than −20° C., more preferentially less than −40° C.

Any extender oil, whether of aromatic or non-aromatic nature, or any liquid plasticizing agent known for its plasticizing properties with regard to diene elastomers, may be used. At ambient temperature (23° C.), these plasticizers or these oils, which are more or less viscous, are liquids (that is to say, as a reminder, substances which have the ability to eventually take on the shape of their container), as opposed, in particular, to hydrocarbon-based plasticizing resins which are by nature solid at ambient temperature.

Liquid plasticizing agents selected from the group consisting of liquid diene polymers (in particular polybutadienes, polyisoprenes, or copolymers of butadiene and/or isoprene and of styrene, or mixtures of these liquid polymers), polyolefin oils, naphthenic oils, paraffinic oils, DAE oils, MES (Medium Extracted Solvate) oils, TDAE (Treated Distillate Aromatic Extract) oils, RAE (Residual Aromatic Extract) oils, TRAE (Treated Residual Aromatic Extract) oils and SRAE (Safety Residual Aromatic Extract) oils, mineral oils, vegetable oils, ether plasticizers, ester plasticizers, phosphate plasticizers, sulphonate plasticizers and mixtures of these compounds are particularly suitable.

Advantageously according to the invention, the liquid plasticizer is biobased, i.e. is based on a compound of plant origin.

In this regard, according to an advantageous embodiment of the invention, the liquid plasticizer is a vegetable oil. By way of example, mention may be made of an oil selected from the group consisting of linseed, safflower, soybean, corn, cottonseed, turnip seed, castor, tung, pine, sunflower, palm, olive, coconut, groundnut and grapeseed oils, and mixtures of these oils. The vegetable oil is preferentially rich in oleic acid, i.e. the fatty acid (or the combined fatty acids, if several are present) from which it derives comprises oleic acid in a weight fraction at least equal to 60%, even more preferentially in a weight fraction at least equal to 70%. Use is advantageously made, as vegetable oil, of a sunflower oil which is such that the combined fatty acids from which it derives comprise oleic acid in a weight fraction equal to or greater than 60%, preferably 70%, and, according to a particularly advantageous embodiment of the invention, in a weight fraction equal to or greater than 80%.

In addition, according to an advantageous embodiment of the invention, the liquid plasticizer is an ester plasticizer selected from the group consisting of triesters of carboxylic acid of plant origin. Among these triesters, mention may be made of glycerol triesters, preferably predominantly consisting (for more than 50%, more preferentially for more than 80%, by weight) of an unsaturated C₁₈ fatty acid, i.e. selected from the group consisting of oleic acid, linoleic acid, linolenic acid and the mixtures of these acids. More preferentially, whether the triester is of synthetic or natural origin (for example in the case of sunflower or rapeseed vegetable oils), the fatty acid used consists, for more than 50% by weight, more preferentially still for more than 80% by weight, of oleic acid. Such triesters having a high content of oleic acid are well known and have been described, for example, in application WO 02/088238 as plasticizing agents in tyre treads.

For the purposes of the invention, the content of specific terpene resin is within a range extending from 10 phr to 80 phr. Preferably, within this range, the content of specific terpene resin is at least 15 phr, more preferably still at least 25 phr, more preferably still at least 30 phr. Also preferably, within this range, the content of specific terpene resin is at most 60 phr, preferably at most 50 phr. The content of specific terpene resin is preferably within a range extending from 15 to 60 phr, more preferably still from 30 to 60 phr.

According to the invention, the weight ratio of terpene resin to liquid plasticizer is greater than or equal to 2/1. A weight ratio of greater than or equal to 2/1 makes it possible to maintain a compromise between rolling resistance and optimal grip of the tyre. Moreover, a weight ratio of greater than or equal to 2/1 also provides a very good level of tear strength. Generally, such a ratio is preferably less than 15/1. According to a preferential embodiment of the invention, this ratio is within a range extending from 2/1 to 10/1, or even extending from 2/1 to 8/1.

According to the invention, the specific terpene resin is a polyterpene selected from alpha-pinene homopolymers, beta-pinene homopolymers, copolymers of alpha-pinene and beta-pinene, and mixtures thereof. The terpene resin according to the invention therefore results from the polymerization of alpha-pinene and/or beta-pinene monomers. It is essentially devoid of units resulting from the polymerization of limonene, i.e. it contains less than 2% by weight thereof relative to the total weight of the polyterpene, preferably less than 1% by weight.

The alpha-pinene and beta-pinene monomers may be obtained from a variety of sources of plant origin. According to one embodiment of the invention, the terpene resin may be obtained from an alpha-pinene-rich monomeric feedstock. According to this embodiment, the alpha-pinene-rich monomeric feedstock may comprise alpha-pinene in an amount of at least 90% by weight, or even 92% by weight to 94% by weight. Alternatively, the terpene resin may be obtained from a beta-pinene-rich monomeric feedstock in the same proportions. These monomeric feedstocks may comprise additional monomers such as alpha-pinene, beta-pinene, camphene, myrcene, carene, dipentene and phellandrene. The terpene-based resin may also be obtained from a mixture of the alpha-pinene-rich feedstock and the beta-pinene-rich feedstock.

The terpene resin according to the invention may comprise alpha-pinene in an amount within a range extending from 1% by weight to 99% by weight or more relative to the total weight of the terpene resin, with the balance up to 100% essentially consisting of beta-pinene.

The terpene resin according to the invention may comprise beta-pinene in an amount within a range extending from 1% by weight to 99% by weight or more, with the balance up to 100% essentially consisting of alpha-pinene.

“Essentially consist” will be understood by those skilled in the art to mean that, depending on the way in which the monomeric feedstocks which are useful for the manufacture of the terpene resins according to the invention are obtained, traces of some specific terpenes other than beta-pinene and alpha-pinene might be present. However, said traces do not have an impact on the characteristics of the terpene resin.

According to a particularly preferred embodiment of the invention, the terpene resin is an alpha-pinene homopolymer, i.e. the terpene resin has a content of alpha-pinene of 99% by weight or more.

According to another particularly preferred embodiment of the invention, the terpene resin is a beta-pinene homopolymer, i.e. the terpene resin has a content of beta-pinene of 99% by weight or more.

According to one embodiment of the invention, the terpene resin has the following characteristics:
(i) a softening point within a range extending from 80° C. to 140° C., preferentially from 110° C. to 135° C.
(ii) a Tg within a range extending from 35° C. to 90° C., preferentially from 60° C. to 85° C.
(iii) a number-average molecular weight within a range extending from 500 g/mol to 1300 g/mol and preferentially from 500 to 1000 g/mol.

The softening point of a resin is measured according to the standard ISO 4625 (ring and ball method).

The Tg is measured by DSC (Differential Scanning Calorimetry) according to the standard ASTM D3418 (1999).

The macrostructure (Mw, Mn and PDI) of the terpene resin is determined by size exclusion chromatography (SEC) based on the standards ISO 16014 (Determination of average molecular mass and molecular mass distribution of polymers using size exclusion chromatography), ASTM D5296 (Molecular Weight Averages and molecular weight distribution of polystyrene by High performance size exclusion chromatography), and DIN 55672 (size exclusion chromatography): solvent tetrahydrofuran; temperature 35° C.; concentration 1 g/l; flow rate 1 ml/min; solution filtered through a filter with a porosity of 0.45 μm before injection; Moore calibration using polystyrene standards; set of three Waters columns in series (STYRAGEL HR4E, HR1 and HR0.5); detection by differential refractometer (Waters 2410) and its associated operating software (Waters Empower).

Terpene resins which are useful in the context of the invention are described for example in document WO2018/057726 A1. They are also commercially available, for example under the names SYLVATRAXX 8125 from Kraton, DERCOLYTE M 115, DERCOLYTE A115, PICCOLYTE A125, DERCOLYTE S115, PICCOLYTE S125 from DRT.

### I-4 Crosslinking System

The crosslinking system may be any type of system known to those skilled in the art in the field of rubber compositions for tyres. It may in particular be based on sulfur and/or on peroxide and/or on bismaleimides.

Preferentially, the crosslinking system is based on sulfur; it is then referred to as a vulcanization system. The sulfur can be provided in any form, in particular in the form of molecular sulfur or of a sulfur-donating agent. At least one vulcanization accelerator is also preferentially present, and, optionally, also preferentially, use may be made of various known vulcanization activators, such as zinc oxide, stearic acid or an equivalent compound, such as stearic acid salts, and salts of transition metals, guanidine derivatives (in particular diphenylguanidine), or known vulcanization retardants.

The sulfur is used in a preferential content of between 0.2 phr and 10 phr, more preferentially between 0.3 and 5 phr. The vulcanization accelerator or mixture of vulcanization accelerators is used in a preferential content of between 0.5 and 10 phr, more preferentially between 0.5 and 5 phr.

Use may be made, as accelerator, of any compound that is capable of acting as an accelerator for the vulcanization of diene elastomers in the presence of sulfur, in particular accelerators of the thiazole type, and also derivatives thereof, or accelerators of sulfenamide, thiuram, dithiocarbamate, dithiophosphate, thiourea and xanthate type. As examples of such accelerators, mention may in particular be made of the following compounds: 2-mercaptobenzothiazyl disulfide (abbreviated as MBTS), N-cyclohexyl-2-benzothiazolesulfenamide (CBS), N,N-dicyclohexyl-2-benzothiazolesulfenamide (DCBS), N-(tert-butyl)-2-benzothiazolesulfenamide (TBBS), N-(tert-butyl)-2-benzothiazolesulfenimide (TBSI), tetrabenzylthiuram disulfide (TBZTD), zinc dibenzyldithiocarbamate (ZBEC) and mixtures of these compounds.

### I-5 Possible Additives

The rubber composition according to the invention may optionally also comprise all or some of the usual additives normally used in elastomer compositions for tyres: pigments, protective agents such as anti-ozone waxes, chemical anti-ozonants, antioxidants, anti-fatigue agents, reinforcing resins, etc.

Needless to say, the compositions in accordance with the invention may be used alone or as a blend (i.e., as a mixture) with any other rubber composition that may be used for the manufacture of rubber articles, in particular of semi-finished articles for tyres, or of tyres.

It goes without saying that the invention relates to the rubber compositions described previously both in the “uncured” or non-crosslinked state (i.e., before curing) and in the “cured” or crosslinked, or else vulcanized, state (i.e., after crosslinking or vulcanization).

### I-6 Preparation of the Rubber Composition

The composition in accordance with the invention may be manufactured in appropriate mixers using two successive preparation phases well known to those skilled in the art:
a first phase of thermomechanical working or kneading (known as the “non-productive” phase), that can be performed in a single thermomechanical step during which all the necessary constituents, in particular the elastomer matrix, the reinforcing filler, the plasticizing system and the various other optional additives, with the exception of the crosslinking system, are introduced into an appropriate mixer, such as a standard internal mixer (for example of “Banbury” type). The filler may be incorporated into the elastomer in one or more portions while thermomechanically kneading. In the case in which the filler is already incorporated, totally or partly, into the elastomer in the form of a masterbatch, as is described, for example, in applications WO 97/36724 or WO 99/16600, it is the masterbatch which is directly kneaded and, if appropriate, the other elastomers or fillers present in the composition which are not in masterbatch form, and also the various other optional additives other than the crosslinking system, are incorporated. The non-productive phase may be performed at high temperature, up to a maximum temperature of between 110° C. and 200° C., preferably between 130° C. and 185° C., for a period of time generally of between 2 and 10 minutes.
a second phase of mechanical working (known as the “productive” phase), which is carried out in an external mixer, such as an open mill, after cooling the mixture obtained during the first non-productive phase down to a lower temperature, typically of less than 120° C., for example between 40° C. and 100° C. The crosslinking system is then incorporated and the combined mixture is then mixed for a few minutes, for example between 5 and 15 min.

Such phases are well known to those skilled in the art.

The final composition thus obtained is then calendered, for example in the form of a sheet or a slab, in particular for laboratory characterization, or else is extruded (or co-extruded with another rubber composition) in the form of a rubber semi-finished product (or profiled element) that may be used in a tyre, for example as a tread. These products may then be used for the manufacture of tyres, according to the techniques known to those skilled in the art.

The composition may be either in the uncured state (before crosslinking or vulcanization) or in the cured state (after crosslinking or vulcanization), or may be a semi-finished product which can be used in a tyre.

The crosslinking (or curing), if appropriate the vulcanization, is carried out in a known way at a temperature generally of between 130° C. and 200° C., for a sufficient time which may vary, for example, between 5 and 90 min depending in particular on the curing temperature, on the crosslinking system adopted and on the kinetics of crosslinking of the composition in question.

### I-7 Semi-Finished Product and Tyre

The rubber composition according to the invention has improved viscoelastic and mechanical properties, in particular with an excellent compromise between hysteresis losses and tan delta at 0° C., while providing good tear strength, or even improved tear strength. A tyre comprising such a composition in its tread is a predictor of an excellent compromise between rolling resistance and wet grip, while providing a very good level of tread block tear strength, and therefore endurance, of the tyre.

For this reason, another subject of the present invention relates to a semi-finished article for a tyre, comprising at least one rubber composition in accordance with the invention and as defined above.

The semi-finished article may be any article which can be used for the manufacture of a finished rubber article such as a tyre. Preferentially, the semi-finished article for a tyre is a tread. The semi-finished articles are obtained via methods that are well known to those skilled in the art.

Another subject of the present invention relates to a tyre comprising at least one rubber composition in accordance with the invention and as described above or comprising at least one semi-finished article for a tyre as described above. The tyres of the invention are obtained via methods that are well known to those skilled in the art.

### II—EXAMPLES

The examples that follow illustrate the invention without, however, limiting it.

### II-1 Manufacture of the Rubber Compositions

For the following tests, the compositions are prepared in the following way: all the components with the exception of the vulcanization system are introduced into an internal mixer which is 70% filled and which has an initial vessel temperature of about 70° C. Thermomechanical working (non-productive phase) is then performed in one step (total kneading time equal to about 5 min), until a maximum “dropping” temperature of about 165° C. is reached.

The mixture thus obtained is recovered and cooled and then the vulcanization system (sulfur and accelerator) is added on an external mixer (homofinisher) at 70° C., everything being mixed (productive phase) for about 5 to 6 min.

The compositions thus obtained are then calendered, either in the form of slabs (thickness of 2 to 3 mm) or thin sheets of rubber for measurement of their physical or mechanical properties after curing.

### II-2: Measurements and Test Used:

### Hysteresis Losses:

The hysteresis losses, denoted PH, are measured as percentage rebound at the sixth rebound at 23° C. in accordance with the following equation:

$$PH ( \% ) = 100 \times ( ( W 0 - W 1 ) / W 1 )$$

in which W0 is the energy supplied and W1 is the energy returned. PH is obtained according to the standard ISO 4662: 2017, by a test using a pendulum which strikes, and rebounds from, a test sample having a thickness of 2.5 mm, a length of 12.5 mm and a width of 3.2.

The rolling resistance is the resistance which appears when the tyre is rolling. It is represented by the hysteresis losses related to the deformation of the tyre during a revolution. The value of the loss at 23° C. thus corresponds to an indication of the rolling resistance of the tyre during running.

The results are indicated in base 100 and are obtained in the following manner: the PH result obtained for a test sample is calculated in base 100, the arbitrary value 100 being assigned to the control:

$$PH results ( base 100 ) = ( PH value of control \times 100 ) / ( PH value of test sample ) .$$

In this way, a result of greater than 100 indicates a decrease in the hysteresis (which is favourable to the rolling resistance).

### Dynamic Properties:

The dynamic properties, and more particularly the hysteresis tan δ, are measured on a viscosity analyser (Metravib VA4000) according to standard ASTM D 5992-96. The response of a sample of vulcanized composition (cylindrical test specimen with a thickness of 4 mm and a cross section of 400 mm²), subjected to a simple alternating sinusoidal shear stress, at a frequency of 10 Hz, under controlled stress conditions (0.7 MPa), is recorded. A temperature amplitude sweep is carried out from −80° C. to 150° C. The result used here is the tan δ value measured at 0° C.

The result is expressed in base 100 by means of the following calculation: An arbitrary value 100 is given to a control composition, a result greater than 100 indicating an increase in the value of tan δ_{0° C.}, therefore corresponding to an improvement in the wet grip performance.

$$tan δ0° C . result ( base 100 ) = ( tan δ0° C . value of the test sample \times 100 ) / ( tan δ0° C . value of the control ) .$$

### PH/tan δ 0° C. Compromise:

This is calculated by adding the PH result and the tan δ 0° C. result, expressed in base 100, and dividing by 2, to express the compromise in base 100.

### Tearability Strength:

The tearability indices are measured at 23° C. In particular, the force to be applied to obtain breaking (FRD, in N/mm of thickness of the test specimen) is determined on a test specimen with dimensions of 10×84×2.5 mm notched at the centre of its length with 3 notches over a depth of 3 mm and a length of between 15 and 20 mm, made before beginning the test using a razor blade, in order to bring about breaking of the test specimen stretched at 375 mm/min. The results are given in base 100, i.e. the values are expressed relative to a control, the breaking strength (FRD) of which is considered as the reference at 100.

### II-3 Tests

### Effect of the Plasticizing System

The aim of these tests is to demonstrate the excellent compromise between hysteresis losses/tan delta at 0° C. (which describes the compromise between rolling resistance and wet grip of a tyre) while improving the tear strength (which describes the tread block tear strength) of rubber compositions according to the invention comprising a specific plasticizing system comprising a terpene resin and an oil, compared to rubber compositions not in accordance with the invention, in which the plasticizing system does not comprise oil.

The control is a rubber composition using a non-terpene hydrocarbon resin, in combination or not in combination with an oil, respectively.

Table 1 presents the characteristics of the resins used in the compositions tested.

TABLE 1

| | | | | Tg | SP* | Mn | Mw |
|---|---|---|---|---|---|---|---|
| Resin | Trade name | Type | Supplier | (° C.) | (° C.) | (g/mol) | (g/mol) |
| 1 | Novares TC130 | DCPD/C9 copolymer | Rütgers | 72 | 129 | 530 | 1230 |
| 2 | Dercolyte A115 | Alpha-pinene homopolymer | DRT | 71 | 118 | 700 | 1040 |
| 3 | Dercolyte A125 | Alpha-pinene homopolymer | DRT | 84 | 125 | 515 | 700 |
| 4 | Dercolyte S115 | Beta-pinene homopolymer | DRT | 68 | 115 | 923 | 2432 |
| 5 | Dercolyte S125 | Beta-pinene homopolymer | DRT | 79 | 125 | 680 | 1480 |

*Softening point

Tables 2a and 2b present the formulations of the rubber compositions C1 to C12. The content of the various ingredients is expressed in phr.

TABLE 2a

| | Control 1 | C1 | C2 | C3 | C4 | C5 | C6 |
|---|---|---|---|---|---|---|---|
| SBR (1) | 100.00 | 100.00 | 100.00 | 100.00 | 100.00 | 100.00 | 100.00 |
| Silica (2) | 80.00 | 80.00 | 80.00 | 80.00 | 80.00 | 80.00 | 80.00 |
| Silane (3) | 6.40 | 6.40 | 6.40 | 6.40 | 6.40 | 6.40 | 6.40 |
| Carbon black (4) | 3.00 | 3.00 | 3.00 | 3.00 | 3.00 | 3.00 | 3.00 |
| Resin 1 (5) | 36.00 | | | | | | |
| Resin 2 (5) | | 36.00 | | | | 18.00 | 27.00 |
| Resin 3 (5) | | | 36.00 | | | | |
| Resin 4 (5) | | | | 36.00 | | 18.00 | 9.00 |
| Resin 5 (5) | | | | | 36.00 | | |
| Oil | 7.00 | 7.00 | 7.00 | 7.00 | 7.00 | 7.00 | 7.00 |
| 6PPD (7) | 2.70 | 2.70 | 2.70 | 2.70 | 2.70 | 2.70 | 2.70 |
| DPG (8) | 2.00 | 2.00 | 2.00 | 2.00 | 2.00 | 2.00 | 2.00 |
| Stearic acid (9) | 2.00 | 2.00 | 2.00 | 2.00 | 2.00 | 2.00 | 2.00 |
| ZnO (10) | 1.00 | 1.00 | 1.00 | 1.00 | 1.00 | 1.00 | 1.00 |
| CBS (11) | 2.30 | 2.30 | 2.30 | 2.30 | 2.30 | 2.30 | 2.30 |
| Solid sulfur (12) | 1.00 | 1.00 | 1.00 | 1.00 | 1.00 | 1.00 | 1.00 |

TABLE 2b

| | Control 2 | C7 | C8 | C9 | C10 | C11 | C12 |
|---|---|---|---|---|---|---|---|
| SBR (1) | 100.00 | 100.00 | 100.00 | 100.00 | 100.00 | 100.00 | 100.00 |
| Silica (2) | 80.00 | 80.00 | 80.00 | 80.00 | 80.00 | 80.00 | 80.00 |
| Silane (3) | 6.40 | 6.40 | 6.40 | 6.40 | 6.40 | 6.40 | 6.40 |
| Carbon black (4) | 3.00 | 3.00 | 3.00 | 3.00 | 3.00 | 3.00 | 3.00 |
| Resin 1 (5) | 36.00 | | | | | | |
| Resin 2 (5) | | 36.00 | | | | 18.00 | 27.00 |
| Resin 3 (5) | | | 36.00 | | | | |
| Resin 4 (5) | | | | 36.00 | | 18.00 | 9.00 |
| Resin 5 (5) | | | | | 36.00 | | |
| 6PPD (7) | 2.70 | 2.70 | 2.70 | 2.70 | 2.70 | 2.70 | 2.70 |
| DPG (8) | 2.00 | 2.00 | 2.00 | 2.00 | 2.00 | 2.00 | 2.00 |
| Stearic acid (9) | 2.00 | 2.00 | 2.00 | 2.00 | 2.00 | 2.00 | 2.00 |
| ZnO (10) | 1.00 | 1.00 | 1.00 | 1.00 | 1.00 | 1.00 | 1.00 |
| CBS (11) | 2.30 | 2.30 | 2.30 | 2.30 | 2.30 | 2.30 | 2.30 |
| Solid sulfur (12) | 1.00 | 1.00 | 1.00 | 1.00 | 1.00 | 1.00 | 1.00 |

(1) Styrene-butadiene copolymer bearing a chain end silanol function, functionalized using a cyclic siloxane function, having a glass transition temperature equal to −65° C., content of 1,2-units is 24%, content of 1,4-cis is 30% and content of 1,4-trans is 46% relative to the butadiene units. The content by weight of styrene is 16%; this copolymer is synthesized according to the process described in EP0778311;
(2) Zeosil 1165 MP silica from Solvay, of HDS type with a BET specific surface area of 160 m²/g;
(3) bis(triethoxysilylpropyl)tetrasulfide polysulfide silane coupling agent sold under the reference Si69 from Evonik-Degussa;
(4) ASTM N234 grade carbon black sold by Cabot;
(5) Resins 1 to 5: see Table 1 above;
(6) Oleic sunflower oil from Cargill;
(7) N-(1,3-Dimethylbutyl)-N′-phenyl-p-phenylenediamine (Santoflex 6-PPD) from Flexsys and 2,2,4-trimethyl-1,2-dihydroquinoline (TMQ);
(8) Diphenylguanidine, Perkacit DPG from Flexsys;
(9) Pristerene 4931 stearin from Uniqema;
(10) Industrial grade zinc oxide from Umicore;
(11) N-Cyclohexyl-2-benzothiazolesulfenamide (Santocure CBS from Flexsys);
(12) Solid sulfur.

### Results

Table 3 presents the results of the measurements carried out.

TABLE 3

| | Control 1 | C1 | C2 | C3 | C4 | C5 | C6 |
|---|---|---|---|---|---|---|---|
| PH 6^{th} impact | 100 | 127 | 126 | 103 | 110 | 116 | 124 |
| tanδ 0° C. (0.7 MPa) | 100 | 92 | 95 | 96 | 90 | 94 | 92 |
| PH/tanδ 0° C. compromise | 100 | 110 | 111 | 100 | 100 | 105 | 108 |
| Tearability at 23° C. | 100 | 102 | 116 | 114 | 109 | 115 | 105 |
| | Control 2 | C7 | C8 | C9 | C10 | C11 | C12 |
| PH 6^{th} impact | 100 | 126 | 122 | 100 | 103 | 111 | 117 |
| tanδ 0° C. (0.7 MPa) | 100 | 97 | 100 | 95 | 95 | 96 | 98 |
| PH/tanδ 0° C. compromise | 100 | 112 | 111 | 98 | 99 | 104 | 108 |
| Tearability at 23° C. | 100 | 94 | 92 | 104 | 102 | 102 | 100 |

It can be seen that the joint use of a plasticizing oil and a terpene resin according to the invention makes it possible to maintain, or even improve, a compromise in the PH/tan δ 0° C. properties which describes the compromise between rolling resistance and wet grip, in particular in light of the control which is considered to have an excellent compromise between properties. Furthermore, the use of a plasticizing oil makes it possible to achieve a tear breaking strength (which can be likened to the tread block tear strength) that is improved compared to the control and that is not observed to the same extent in mixtures which do not contain plasticizing oil.

Effect of the Resin/Oil Ratio within the Plasticizing System

The aim of these tests is to demonstrate the excellent compromise between hysteresis losses/tan delta at 0° C. (which describes the compromise between rolling resistance and wet grip of a tyre) while improving the tear strength (which describes the tread block tear strength) of rubber compositions according to the invention comprising a specific plasticizing system comprising a terpene resin and an oil at a resin/oil weight ratio of 2/1, compared to rubber compositions not in accordance with the invention, in which the plasticizing system comprises a terpene resin and an oil at a resin/oil weight ratio of 1.4 to 1.

The control is a rubber composition using a non-terpene hydrocarbon resin at a resin/oil weight ratio of 2/1 and 1.4/1, respectively.

Table 4 presents the formulations of the rubber compositions D1 to D4. The content of the various ingredients is expressed in phr.

TABLE 4

| | Control 3 | D1 | D2 | Control 4 | D3 | D4 |
|---|---|---|---|---|---|---|
| SBR (1) | 100.00 | 100.00 | 100.00 | 100.00 | 100.00 | 100.00 |
| Silica (2) | 80.00 | 80.00 | 80.00 | 80.00 | 80.00 | 80.00 |
| Silane (3) | 6.40 | 6.40 | 6.40 | 6.40 | 6.40 | 6.40 |
| Carbon black (4) | 3.00 | 3.00 | 3.00 | 3.00 | 3.00 | 3.00 |
| Resin 1 (5) | 36.00 | | | 25.00 | | |
| Resin 3 (5) | | 36.00 | | | 25.00 | |
| Resin 4 (5) | | | 36.00 | | | 25.00 |
| Oil (6) | 18.00 | 18.00 | 18.00 | 18.00 | 18.00 | 18.00 |
| 6PPD (7) | 2.70 | 2.70 | 2.70 | 2.70 | 2.70 | 2.70 |
| DPG (8) | 2.00 | 2.00 | 2.00 | 2.00 | 2.00 | 2.00 |
| Stearic acid (9) | 2.00 | 2.00 | 2.00 | 2.00 | 2.00 | 2.00 |
| ZnO (10) | 1.00 | 1.00 | 1.00 | 1.00 | 1.00 | 1.00 |
| CBS (11) | 2.30 | 2.30 | 2.30 | 2.30 | 2.30 | 2.30 |
| Solid sulfur (12) | 1.00 | 1.00 | 1.00 | 1.00 | 1.00 | 1.00 |

| | | |
|---|---|---|
| Resin/oil weight ratio | 2/1 | 1.4/1 |

(1) Styrene-butadiene copolymer bearing a chain end silanol function, functionalized using a cyclic siloxane function, having a glass transition temperature equal to −65° C., content of 1,2-units is 24%, content of 1,4-cis is 30% and content of 1,4-trans is 46% relative to the butadiene units. The content by weight of styrene is 16%; this copolymer is synthesized according to the process described in EP0778311;
(2) Zeosil 1165 MP silica from Solvay, of HDS type with a BET specific surface area of 160 m²/g;
(3) bis(triethoxysilylpropyl)tetrasulfide polysulfide silane coupling agent sold under the reference Si69 from Evonik-Degussa;
(4) ASTM N234 grade carbon black sold by Cabot;
(5) Resins 1 to 5: see Table 1 above;
(6) Oleic sunflower oil from Cargill;
(7) N-(1,3-Dimethylbutyl)-N′-phenyl-p-phenylenediamine (Santoflex 6-PPD) from Flexsys and 2,2,4-trimethyl-1,2-dihydroquinoline (TMQ);
(8) Diphenylguanidine, Perkacit DPG from Flexsys;
(9) Pristerene 4931 stearin from Uniqema;
(10) Industrial grade zinc oxide from Umicore;
(11) N-Cyclohexyl-2-benzothiazolesulfenamide (Santocure CBS from Flexsys);
(12) Solid sulfur.

### Results

Table 5 presents the results of the measurements carried out.

TABLE 5

| | Control | | | Control | | |
|---|---|---|---|---|---|---|
| | 3 | D1 | D2 | 4 | D3 | D4 |
| Resin/oil weight ratio | 2/1 | | | 1.4/1 | | |
| PH 6^{th} impact | 100 | 145 | 128 | 100 | 117 | 108 |
| tanδ 0° C. (0.7 MPa) | 100 | 89 | 105 | 100 | 88 | 105 |
| PH/tanδ 0° C. | 100 | 117 | 116 | 100 | 102 | 106 |
| compromise | | | | | | |
| Tearability at 23° C. | 100 | 200 | 233 | 100 | 90 | 95 |

It can be seen that the joint use of a terpene resin and a plasticizing oil at a weight ratio of 2/1 according to the invention makes it possible to improve a compromise in the PH/tan δ 0° C. properties which describes the compromise between rolling resistance and wet grip, in particular in light of the control which is considered to have an excellent compromise between properties.

Furthermore, the joint use of a terpene resin and a plasticizing oil at a weight ratio of 2/1 makes it possible to achieve a tear breaking strength (which can be likened to the tread block tear strength) that is very significantly improved compared to the control, while in mixtures containing a terpene resin and a plasticizing oil at a resin/oil weight ratio of less than 2/1, in this instance of 1.4/1, a degradation in this property is observed compared to the control.

1.-15. (canceled)

16. A rubber composition based on at least:
an elastomer matrix consisting of an SBR or of a mixture of one SBR and at least one other SBR;
a reinforcing filler comprising silica;
a plasticizing system comprising 2 to 50 phr of a liquid plasticizer, and 10 phr to 80 phr of a terpene resin selected from the group consisting of alpha-pinene homopolymers, beta-pinene homopolymers, copolymers of alpha-pinene and beta-pinene, and mixtures thereof, a weight ratio of the terpene resin to the liquid plasticizer being greater than or equal to 2/1; and
a crosslinking system.

17. The rubber composition according to claim 16, wherein at least one SBR has a Tg of greater than −70° C., the Tg being determined using a differential calorimeter according to standard ASTM D3418 (1999).

18. The rubber composition according to claim 16, wherein the elastomer matrix consists of a single SBR.

19. The rubber composition according to claim 16, wherein at least one SBR is an SBR modified with a group comprising an SiOR or SiOH function, R being a C1-C4 alkyl.

20. The rubber composition according to claim 16, wherein at least one SBR is an SBR modified with a group comprising a silanol function SiOH located at the chain end.

21. The rubber composition according to claim 16, wherein at least one SBR is an SBR modified with an amine function and a group comprising an SiOR or SiOH function, R being a C1-C4 alkyl.

22. The rubber composition according to claim 16, wherein the reinforcing filler predominantly comprises silica.

23. The rubber composition according to claim 16, wherein the reinforcing filler comprises silica in a content within a range extending from 40 phr to 160 phr.

24. The rubber composition according to claim 16, wherein the content of liquid plasticizer is within a range extending from 5 to 30 phr.

25. The rubber composition according to claim 16, wherein the liquid plasticizer is a vegetable oil or a glycerol triester of plant origin.

26. The rubber composition according to claim 16, wherein the content of the terpene resin is within a range extending from 15 to 60 phr.

27. The rubber composition according to claim 16, wherein the terpene resin is selected from the group consisting of alpha-pinene homopolymers and beta-pinene homopolymers.

28. The rubber composition according to claim 16, wherein the terpene resin has the following characteristics:
(i) a softening point within a range extending from 80° C. to 140° C.;
(ii) a Tg within a range extending from 35° C. to 90° C.; and
(iii) a number-average molecular weight within a range extending from 500 g/mol to 1300 g/mol.

29. A finished or semi-finished product comprising the rubber composition according to claim 16.

30. A tire comprising the rubber composition according to claim 16.
